(19) United States
(12) Patent Application Publication
(10) Pub. No.: US 2019/0202087 A1
(43) Pub. Date: Jul. 4, 2019

(54) METHOD FOR PRODUCING EXPANDED GRANULAR MATERIAL

(71) Applicant: BASF SE, Ludwigshafen am Rhein (DE)

(72) Inventors: Jerome LOHMANN, Ludwigshafen am Rhein (DE); Peter GUTMANN, Ludwigshafen am Rhein (DE); Bangaru Dharmapuri Sriramulu SAMPATH, Ludwigshafen am Rhein (DE); Andreas KUENKEL, Ludwigshafen am Rhein (DE); Juergen AHLERS, Ludwigshafen am Rhein (DE); Uwe KEPPELER, Ludwigshafen am Rhein (DE); Thomas HEITZ, Ludwigshafen am Rhein (DE); Jens-Uwe SCHIERHOLZ, Ludwigshafen am Rhein (DE)

(21) Appl. No.: 16/323,664

(22) PCT Filed: Aug. 1, 2017
(86) PCT No.: PCT/EP2017/069424

§ 371 Date: Feb. 6, 2019

(30) Foreign Application Priority Data
Aug. 8, 2016 (EP) 16183173.0

(51) Int. Cl. B29B 9/06; B29B 9/14; B29C 48/00; C08L 67/02

(52) U.S. Cl. CPC B29B 9/065; B29B 9/14; B29K 2033/04; B29C 48/0022; C08L 67/02; B29C 48/0012

(57) ABSTRACT

The invention relates to a process for production of expanded foam beads of one or more polyesters based on aliphatic or aliphatic and aromatic dicarboxylic acids and aliphatic diols, comprising the steps of:
(a) melting the polyester and admixing the polyester with 1 to 3.5 wt %, based on the polyester, of a carbon dioxide and/or nitrogen blowing agent and also 0.1 to 2 wt % of a nucleating agent, and pressing the nucleated polyester melt, containing blowing agent, through a perforated disk controlled to a temperature between 150° C. and 185° C. and into a pelletizing chamber,
(b) using a cutting device to comminute the polymer melt pressed through the perforated disk into individual expanding pellets,
(c) discharging the pellets from the pelletizing chamber into a stream of water which is at a temperature of 5 to 90° C. and a pressure of 0.1 bar to 20 bar above ambient pressure.

The invention relates to a process for production of expanded foam beads of one or more polyesters based on aliphatic or aliphatic and aromatic dicarboxylic acids and aliphatic diols, comprising the steps of:
(a) melting the polyester and admixing the polyester with 1 to 3.5 wt %, based on the polyester, of a carbon dioxide and/or nitrogen blowing agent and also 0.1 to 2 wt % of a nucleating agent, and pressing the nucleated polyester melt, containing blowing agent, through a perforated disk controlled to a temperature between 150° C. and 185° C. and into a pelletizing chamber,
(b) using a cutting device to comminute the polymer melt pressed through the perforated disk into individual expanding pellets,
(c) discharging the pellets from the pelletizing chamber into a stream of water which is at a temperature of 5 to 90° C. and a pressure of 0.1 bar to 20 bar above ambient pressure.

WO 2015/052020 discloses a process for production of expanded foam beads from a biodegradable polyester based on aliphatic, or aliphatic and aromatic, dicarboxylic adds and aliphatic diols. That process, known as an autoclave process, imposes exacting requirements on the technical apparatus and on the observation of operational parameters. One objective of the present invention was to find a process which is easy to carry out and is operable—such as the extrusion process identified at the outset—that yields quasi-expanded foam beads with low bulk densities of preferably less than 150 g/l.

The use of an extrusion process to produce expanded pellets permits continuous production and hence rapid processing of a variety of hardnesses and also the rapid switch between further properties, as for example the color of the expanded beads produced.

Yet there is a problem with the direct production of expanded pellets via extrusion in that the beads expand without an uninterrupted skin forming in the process, and the expanded beads collapse, making it impossible to produce beads of low bulk density. It is similarly disadvantageous that the blowing agents used are flammable and so are difficult to process because of an ever-present risk of explosion. Furthermore, the expanded pellets produced have to be stored until the flammable agent used has volatilized, before they can be shipped out.

In the production of expanded foam beads by extrusion processes, blowing agents used are generally volatile organic compounds, the use of which attracts safety impositions. WO 2014/198779 describes an extrusion process for production of expanded foam beads from, among other materials, aromatic polyesters, this process operating without organic blowing agents. Application of that process to the production of foam beads from biodegradable polyesters, however, has not afforded satisfactory results. The bulk density of the expanded foam beads was more than 150 g/l.

An object of the present invention was to find an extrusion process for production of expanded foam beads that does not have the disadvantages identified above. The process of the invention achieves this object, particularly by the significant lowering of the temperature in the extruder and at the perforated disk to below or equal to 185° C. and preferably below or equal to 180° C.

Furthermore, two preferred embodiments of the process have been found:

one preferred process has the following steps:
(a) melting the polyester and admixing the polyester with 1 to 3.5 wt %, based on the polyester, of a blowing agent mixture of carbon dioxide and nitrogen in a ratio of 10:1 to 2:1, and also with 0.1 to 2 wt % of a nucleating agent, and pressing the nucleated polyester melt, containing blowing agent, through a perforated disk controlled to a temperature between 150° C. and 185° C. and into a pelletizing chamber,
(b) using a cutting device to comminute the polymer melt pressed through the perforated disk into individual expanding pellets,
(c) discharging the pellets from the pelletizing chamber into a stream of water which is at a temperature of 5 to 90° C. and a pressure of 4 bar to 20 bar, and especially preferably 10 to 15 bar, above ambient pressure.

Another preferred process has the following steps:
(a) melting the polyester and admixing the polyester with 1 to 3.5 wt %, based on the polyester, of the blowing agent carbon dioxide, and also with 0.1 to 2 wt % of a nucleating agent, and pressing the nucleated polyester melt, containing blowing agent, through a perforated disk controlled to a temperature between 150° C. and 185° C. and into a pelletizing chamber,
(b) using a cutting device to comminute the polymer melt pressed through the perforated disk into individual expanding pellets,
(c) discharging the pellets from the pelletizing chamber into a stream of water which is at a temperature of 5 to 90° C. and a pressure of 0.5 bar to 5 bar, and especially preferably 1 to 4 bar, above ambient pressure.

Surprisingly it has emerged that the lowest bulk densities are obtained not, as expected, with maximum quantities of blowing agent, but that instead a blowing agent quantity of not more than 3.5 wt %, preferably not more than 2.5 wt % and more particularly not more than 2 wt %, leads to particularly low bulk density. At a blowing agent quantity of less than 1 wt %, there is likewise an increase in the bulk density. The respective mass fractions are based on the total mass of the polymer melt with blowing agent contained therein.

The optimum quantity of blowing agent to be employed is dependent on the thermoplastic elastomer used and on the composition of the blowing agent, but is always within the range between 1 and 3.5 wt %.

In step (a) of the process, a polymer melt mixed with a blowing agent and optionally with further adjuvants is forced through the perforated disk. The production of the polymer melt comprising blowing agent and, optionally, further adjuvants is accomplished in general by means of an extruder and/or a melt pump. These apparatuses are also utilized to generate the necessary pressure with which the polymer melt is pressed through the perforated disk. When using an extruder, a twin-screw extruder for example, the polymer is first plasticated and optionally mixed with auxiliaries. During mixing, the material within the extruder is transported in the direction of the temperature-controlled perforated disk. If the blowing agent was not inserted into the extruder from the start, together with the polymer, it may be added to the material after the latter has traveled part of the distance in the extruder. The blowing agent and the polymer are mixed during travel over the remaining distance in the extruder. In this process, the melt is brought to the temperature required for the subsequent pelletization, of 150 to 185° C. and preferably 160 to 180° C. The pressure needed for pressing the melt through the perforated disk may be applied, for example, using a melt pump. Alternatively, the required pressure is generated by the corresponding geometry of the extruder and, in particular, of the extruder screw. The polymer melt passes through the temperature-controlled perforated disk and into the pelletizing chamber.

The pelletizing chamber is traversed by a flow of a temperature-controlled liquid, the pressure of which is 0.1 bar to 20 bar above the ambient pressure. When a blowing agent mixture of carbon dioxide and nitrogen in a mixing ratio of 10:1 to 2:1 is used, the water pressure in the pelletizing chamber is preferably 4 to 20 bar and especially preferably 5 to 15 bar above the ambient pressure. Overall, this regime affords expanded foam beads having ideally spherical or slightly elliptical shape and a homogeneous distribution of density over the entirety of the foam beads. It is, however, also possible to use exclusively carbon dioxide as blowing agent; in a regime of this kind, the water pressure is preferably 0.5 to 5 bar.

In the pelletizing chamber, the polymer forced through the temperature-controlled perforated disk is shaped into strands which a cutting device comminutes into individual expanding pellets. The cutting device may be embodied as a fast-rotating blade, for example. The shape of the resulting pellets is dependent on the shape and size of the openings in the perforated disk and also on the pressure at which the melt is forced through the holes in the perforated disk, and on the speed of the cutting device. It is preferable for the forcing pressure, the speed of the cutting device, and the size of the openings in the perforated disk to be chosen such that the shape of the pellets is substantially spherical or elliptical.

In the last step of the process, (c), the pellets are discharged from the pelletizing chamber by the temperature-controlled water flowing through the pelletizing chamber. The choice of pressure and temperature for the water is such that the polymer strands/pellets are subjected to controlled expansion by the blowing agent they contain, and an uninterrupted and uniform skin is formed on the surface of the pellets.

The pellets flow together with the temperature-controlled water into a drier, where they are separated from the water. The final expanded pellets are collected in a container, while the water is filtered and returned back into the pelletizing chamber via a pressure pump.

The underwater pelletization is carried out, as mentioned above, in general at 5 to 90° C. and preferably 30 to 80° C. and a pressure of 0.1 to 20 bar above ambient pressure. For the water pressure, the preferred embodiments described above have proven advantageous. The controlled water temperature and the specific water pressure prevent uncontrolled expansion of the blowing agent-containing polymer melt, with an uninterrupted skin unable to form. While such beads would to start with have a low bulk density, they would nevertheless soon collapse in on themselves. The outcome would be inhomogeneous beads of high bulk density and low elasticity. The process of the invention provides controlled braking of pellet expansion, forming structured pellets which possess an uninterrupted skin and which within their interior have a cellular structure, with the cell size at the surface being small and increasing toward the center. The size of the cells in the center is preferably less than 450 μm. The bulk density of the expanded pellets is preferably not more than 250 g/l and especially preferably not more than 150 g/l. The maximum extent of the individual expanded pellets is preferably in the range from 2 to 15 mm, more particularly in the range from 5 to 12 mm, and the mass of an individual pellet is between 2 and 40 mg, more particularly between 5 and 35 mg.

Expansion of the pellets is controlled by adjustment to water pressure and temperature in the pelletizing chamber and also to the temperature of the perforated disk. If the pellets expand too quickly or with insufficient control, causing an interrupted skin to form, the water pressure in the pelletizing chamber is increased and/or the water temperature in the pelletizing chamber is lowered. The increased pressure of the temperature-controlled water surrounding the pellets counteracts the expansion effect of the blowing agent and puts a brake on pellet expansion. The effect of reducing the water temperature in the pelletizing chamber is to thicken the skin of the beads and to present greater resistance, therefore, to expansion. At too low a water temperature or too high a water pressure in relation to the blowing agent used, expansion of the pellets may be excessively hindered or even prevented entirely, causing pellets with too great a bulk density to be produced. In that case the water pressure in the pelletizing chamber is lowered, and/or the water temperature raised.

In addition to adaptation of the water pressure and/or the water temperature in the pelletizing chamber, the expansion of the pellets can be influenced in particular by the temperature of the perforated disk. Lowering the temperature of the temperature-controlled perforated disk allows heat to be released from the polymer melt more quickly to the environment. This promotes the formation of an uninterrupted skin, which is the requirement for stable, foamed pellets. If the temperature chosen for the temperature-controlled perforated disk and/or for the water in the pelletizing chamber is too low, the polymer melt cools too quickly and solidifies before sufficient expansion is able to ensue. The expansion of the pellets by the blowing agent they contain is hindered to such an extent that the resulting pellets have an excessive bulk density. Accordingly, in such a case, the water temperature in the pelletizing chamber and/or the temperature of the temperature-controlled perforated disk are/is increased.

The water temperature in the pelletizing chamber in accordance with the invention is between 5° C. and 90° C., and preferably is 30 to 80° C. The temperature of the temperature-controlled perforated disk is, in accordance with the invention, between 150° C. and 185° C., a preferred perforated disk temperature being between 160° C. and 180° C.

Too high a perforated disk temperature leads to a thin skin on the surface of the beads and to subsequent collapse of the surface. Excessively low perforated disk temperatures reduce the degree of expansion and lead to thick, unfoamed bead surfaces.

A further preferred process operates without the aliphatic or aliphatic-aromatic polyester being isolated beforehand. In the case of production of foam beads from expanded thermoplastic elastomer, a reactive extrusion in the first step is described in WO 2015/055811. Here, the polyester, which has been produced discontinuously (batch mode), semicontinuously or continuously in a first stage (x), is introduced directly in melt form via a heated pipeline into stage (a). This allows energy and also costs to be saved on the pelletizing and the subsequent melting of the polyester.

In detail, this process alternative is as follows:

A process for production of expanded foam beads of a polyester based on aliphatic or aliphatic and aromatic dicarboxylic acids and aliphatic diols, comprising the steps of:
(x) adding aliphatic or aliphatic and aromatic dicarboxylic acids and aliphatic diols, and optionally further reactants, that are used for preparing a polyester melt, into a first stage of a polymer processing machine,
(a) introducing the polyester melt into a second polymer processing machine and admixing the polyester melt with 1 to 3.5 wt %, based on the polyester, of blowing agent carbon dioxide and/or nitrogen and also 0.1 to 2 wt % of a nucleating agent, and pressing the nucleated polyester melt, containing blowing agent, through a perforated disk controlled to a temperature between 150° C. and 185° C. and into a pelletizing chamber,
(b) using a cutting device to comminute the polymer melt pressed through the perforated disk into individual expanding pellets,
(c) discharging the pellets from the pelletizing chamber into a stream of water which is at a temperature of 5 to 90° C. and a pressure of 0.1 bar to 20 bar above ambient pressure.

The design of the polymer processing machine differs according to whether the polyester is being produced discontinuously, semicontinuously or continuously. In the case of a discontinuous or semicontinuous process, reaction tanks or a tank cascade, in particular, are suitable.

In the case of the continuous process, a reaction design as described in WO 2009/127556, in particular, is preferred for stage (x).

In WO 2009/127556, for example, a mixture of aliphatic, or aliphatic and aromatic, dicarboxylic acids and aliphatic diols, and optionally further reactants, is mixed to a paste, without addition of a catalyst, or alternatively the liquid esters of the dicarboxylic acids, and the dihydroxy compound and any further comonomers, without addition of a catalyst, are fed into the reactor, and
1. in a first stage this mixture, together with the entire amount or a partial amount of the catalyst, is continuously esterified or, respectively, transesterified;
2. in a second stage, the transesterification or esterification product obtained as per 1.) is subjected to precondensation, optionally with the remaining amount of catalyst, and continuously, preferably in a tower reactor, with the product stream being passed cocurrentwise via a falling film cascade, and the reaction vapors being removed in situ from the reaction mixture, such condensation taking place until the DIN 53728 viscosity number is from 20 to 60 mL/g;
3. in a third stage, the product obtainable from 2.) is subjected to polycondensation, continuously, preferably in a cage reactor, until the DIN 53728 viscosity number is from 70 to 130 mL/g, and
4. in a fourth stage, continuously, the product obtainable from 3.) is reacted to a DIN 53728 viscosity number of 160 to 250 mL/g in a polyaddition reaction with a chain extender in an extruder, List reactor or static mixer.

Using the process described in WO 2009/127556, access may be had to aliphatic-aromatic or aliphatic polyesters with low acid numbers as measured to DIN EN 12634 of less than 1.0 mg KOH/g and with an ISO 1133 MVR of 0.5 to 10 cm³/10 min, preferably 0.5 to 6 cm³/10 min (190° C., 2.16 kg weight), these polyesters being outstandingly suitable for direct introduction in melt form into stage (a) according to the invention. There is no need for further purification or adaptation of the polyesters.

One of the reasons why the process described in WO 2009/127556 is highly suitable as primary stage (x) is because the preferred melt volume rate (MVR) according to ISO 1133, of 0.5 to 10 cm³/10 min (190° C., 2.16 kg), can be established very easily by addition of a chain extender. A preferred chain extender used here is hexamethylene diisocyanate.

In the present process, the chain extender can not only be used in stage (x) as in WO 2009/127556, but can also be added in stage (a) before or simultaneously with the addition of the blowing agent and the nucleating agent.

Stage (a) is carried out preferably in an extruder such as, for example, a twin-screw extruder, List reactor or static mixer. In the aforesaid reaction vessels, the blowing agent, the nucleating agent and, optionally, the chain extender can be distributed homogeneously in the polyester melt.

In one embodiment the first stage (x) of the polymer processing machine is followed by a melt channel with the feed port for the physical blowing agent and nucleating agent as stage (a). In this case the stage (a) further comprises a melt pump and a static mixer. The melt channel is, for example, a heatable tube through which the polymer melt flows and into which the physical blowing agent and the nucleating agent can be introduced. An injection valve may likewise be provided for this purpose, and a gas metering unit used to add the blowing agent. The melt pump builds the necessary pressure required to press the polymer melt through the static mixer and the pelletizing tool after the physical blowing agent has been added. The melt pump may be situated either between the melt channel and the static mixer or, alternatively, between the first stage and the melt channel. If the melt pump is positioned between the melt channel and the static mixer, it is necessary to configure the first stage (x) such that pressure is built up in the first stage (x), during the conversion of the monomers and/or oligomers to the polymer, and, additionally, such that the pressure is sufficient to convey the polymer melt through the melt channel also. For this purpose it is necessary, additionally, to connect the melt channel to the first stage (x), either directly or via a pipeline.

Biodegradable polyesters suitable for the process of the invention for production of expanded pellets, and based on aliphatic, or aliphatic and aromatic, dicarboxylic acids and aliphatic dihydroxy compounds, are described below. Latter polyesters are also termed partly aromatic polyesters. Common to these polyesters is that they are biodegradable to DIN EN 13432. Mixtures of two or more such polyesters are of course also suitable.

The particularly preferred biodegradable polyesters include polyesters comprising as essential components:
A1) 40 to 100 mol %, based on components A1) to A2), of an aliphatic C₄-C₁₈ dicarboxylic acid or mixtures thereof,
A2) 0 to 60 mol %, based on components A1) to A2), of an aromatic dicarboxylic acid or mixtures thereof,
B) 98.5 to 100 mol %, based on components A1) to A2), of a diol component comprising a C2 to C12 alkanediol or mixtures thereof, and
C) 0.05 to 1.5 wt %, based on components A1) to A2) and B, of one or more compounds selected from the group consisting of:
   C1) a compound having at least three groups capable of forming esters,
   C2) a compound having at least two isocyanate groups, and
   C3) a compound having at least two epoxide groups.

Partly aromatic polyesters for the purposes of the invention also include polyester derivatives which contain up to 10 mol % of functions other than ester functions, such as polyetheresters, polyesteramides or polyetheresteramides, and polyesterurethanes. The suitable partly aromatic polyesters include linear polyesters that have not been chain-extended (WO 92/09654). Preference is given to chain-extended and/or branched, partly aromatic polyesters. The latter are known from the aforementioned specifications WO 96/15173 to 15176, 21689 to 21692, 25446, 25448, or WO 98/12242, expressly incorporated by reference. Mixtures of different partly aromatic polyesters are also contemplated. Interesting recent developments are based on renewable raw materials (see WO-A 2006/097353, WO-A 2006/097354, and EP 2331603). The term “partly aromatic polyesters” refers in particular to products such as Ecoflex® (BASF SE) and Eastar® Bio, Origo-Bi® (Novamont).

The particularly preferred partly aromatic polyesters include polyesters comprising as essential components:
A1) 40 to 60 mol %, preferably 45 to 60 mol %, based on components A1) to A2), of an aliphatic dicarboxylic acid selected from the group consisting of succinic acid, adipic acid, sebacic acid, and azelaic acid, or mixtures thereof,
A2) 40 to 60 mol %, preferably 40 to 55 mol %, based on components A1) to A2), of an aromatic dicarboxylic acid selected from the group consisting of terephthalic acid and 2,5-furane dicarboxylic acid or mixtures thereof,
B) 98.5 to 100 mol %, based on components A1) to A2), of a diol component comprising a C2 to C4 alkanediol, preferably a 1,3-propanediol or 1,4-butanediol, or mixtures thereof, and
C) 0.05 to 1.5 wt %, based on components A1) to A2) and B, of one or more compounds selected from the group consisting of:
   C1) a compound having at least three groups capable of forming esters, preferably glycerol or pentaerythritol,
   C2) a compound having at least two isocyanate groups, preferably 1,6-hexamethylene diisocyanate or 1,6-hexamethylene diisocyanurate, and
   C3) a compound having at least two epoxide groups, preferably a copolymer of styrene, glycidyl (meth)acrylate, and (meth)acrylate.

Aliphatic acids and the corresponding derivatives, A1, that are contemplated include in general those having 4 to 18 carbon atoms, preferably 4 to 10 carbon atoms, especially preferably 4 to 10 carbon atoms. They may be both linear and branched. In principle, however, dicarboxylic acids having a larger number of carbon atoms can also be used, with up to 30 carbon atoms, for example.

Examples include the following: succinic add, glutaric acid, 2-methylglutaric acid, 3-methylglutaric acid, α-ketoglutaric acid, adipic acid, pimelic acid, azelaic acid, sebacic acid, brassylic acid, fumaric acid, 2,2-dimethylglutaric acid, suberic acid, diglycolic acid, glutamic acid, aspartic acid, itaconic acid and maleic acid. The dicarboxylic acids or their ester-forming derivatives may be used, individually or as a mixture of two or more thereof.

Preferred for use are succinic acid, adipic acid, azelaic acid, sebacic acid or their respective ester-forming derivatives or mixtures thereof. Particularly preferred for use is succinic acid, adipic acid or sebacic acid, or their respective ester-forming derivatives or mixtures thereof. Succinic acid, azelaic acid, sebacic acid, and brassylic acid have the advantage, moreover, that they are obtainable from renewable raw materials.

Especially preferred are the following aliphatic-aromatic polyesters: polybutylene adipate-coterephthalate (PBAT), polybutylene sebacate-coterephthalate (PBSeT) or polybutylene succinate-coterephthalate (PBST), and very preferably polybutylene adipate terephthalate (PBAT) and polybutylene sebacate terephthalate (PBSeT).

Additionally preferred are mixtures of polybutylene adipate terephthalate (PBAT) and polybutylene sebacate terephthalate (PBSeT).

The aromatic dicarboxylic acids or their ester-forming derivatives A2 may be used individually or as a mixture of two or more thereof. Particularly preferred for use are terephthalic acid and 2,5-furandicarboxylic acid, or their ester-forming derivatives such as dimethyl terephthalate or dimethyl furanate.

The diols B are generally selected from branched or linear alkanediols having 2 to 12 carbon atoms, preferably 3 to 6 carbon atoms, or cycloalkanediols having 5 to 10 carbon atoms.

Examples of suitable alkanediols are ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, especially ethylene glycol, 1,3-propanediol, 1,4-butanediol, and 2,2-dimethyl-1,3-propanediol (neopentyl glycol). Particularly preferred are 1,4-butanediol and 1,3-propanediol, which have the advantage, moreover, that they are obtainable as renewable raw material. Mixtures of different alkanediols may also be used.

The preferred partly aromatic polyesters are characterized by a number-average molecular weight (Mn) in the range from 1000 to 100 000, more particularly in the range from 9000 to 75 000 g/mol, preferably in the range from 10 000 to 50 000 g/mol, and by a melting point in the range from 60 to 170, preferably in the range from 80 to 150° C.

The EN ISO 1133 melt volume rate (MVR) (190° C., 2.16 kg weight) of the partly aromatic polyesters is situated in general at 0.1 to 50, preferably at 0.5 to 10, and especially preferably at 1 to 5 cm³/10 minutes.

Aliphatic, biodegradable polyesters are understood to be polyesters of aliphatic diols and aliphatic dicarboxylic acids such as polybutylene succinate (PBS), polybutylene adipate (PBA), polybutylene succinate-coadipate (PBSA), polybutylene succinate-cosebacate (PBSSe), polybutylene sebacate (PBSe), or corresponding polyesteramides or polyesterurethanes. The aliphatic polyesters are marketed for example by Showa Highpolymers under the Bionolle® name and by Mitsubishi under the GSPLA name. More recent developments are described in WO 2010/034711.

The aliphatic polyesters are preferably composed of the following components:
Ai) 90 to 100 mol %, based on components Ai to Aii, of succinic acid;
Aii) 0 to 10 mol %, based on components Ai to Aii, of one or more C6-C18 dicarboxylic acids;
B) 99 to 100 mol %, based on components Ai to Aii and B, of 1,3-propanediol or 1,4-butanediol or mixtures thereof;
C) 0 to 1 wt %, based on components Ai to Aii, B and C, of a diisocyanate, preferably 1,6-hexamethylene diisocyanate, and/or a compound having at least three groups capable of forming esters, preferably glycerol or pentaerythritol.

The biodegradable polyesters may also comprise mixtures of the above-described partly aromatic polyesters and purely aliphatic polyesters, such as, for example, mixtures of polybutylene adipate-coterephthalate and polybutylene succinate.

The expanded pellets produced by the process of the invention may comprise further adjuvants such as dyes, pigments, fillers, flame retardants, synergistics for flame retardants, antistats, stabilizers (such as hydrolysis stabilizers, for example), surface-active substances, plasticizers, and infrared opacifiers, in effective amounts.

Suitable infrared opacifiers to reduce the radiative contribution to thermal conductivity include, for example, metal oxides, nonmetal oxides, metal powders, for example aluminum powders, carbon, for example carbon black, graphite or diamond, or organic dyes and pigment dyes. The use of infrared opacifier is advantageous especially for applications at high temperatures. Particularly preferred as infrared opacifiers are carbon black, titanium dioxide, iron oxides or zirconium dioxide. The aforementioned materials can be used not only each on its own but also in combination, in other words in the form of a mixture of two or more materials. If fillers are used, they may be organic and/or inorganic.

If fillers are present, they are, for example, organic and inorganic powders or fibrous materials and also mixtures thereof. Organic fillers which can be used include, for example, wood flour, starch, flax fibers, hemp fibers, ramie fibers, jute fibers, sisal fibers, cotton fibers, cellulose fibers or aramid fibers. Examples of suitable inorganic fillers include silicates, barite, glass beads, zeolites, metals or metal oxides. Particularly preferred for use are pulverulent inorganic substances such as chalk, kaolin, aluminum hydroxide, magnesium hydroxide, aluminum nitrite, aluminum silicate, barium sulfate, calcium carbonate, calcium sulfate, silica, finely ground quartz, Aerosil, argillaceous earth, mica or wollastonite, or inorganic substances in bead or fiber form, examples being iron powders, glass beads, glass fibers or carbon fibers. The average particle diameter or, in the case of fibrous fillers, the length of the fibers ought to be in the region of the cell size or less. Preference is given to an average particle diameter or average fiber length in the range from 0.1 to 100 μm, more particularly in the range from 1 to 50 μm.

Preference is given to expanded containing between 5 and 80 wt %, especially preferably 5 to 20 wt %, of organic and/or inorganic fillers, based on the total weight of the system containing blowing agent.

Suitable flame retardants are, for example, tricresyl phosphate, tris(2-chloroethyl) phosphate, tris(2-chloropropyl) phosphate, tris(1,3-dichloropropyl) phosphate, tris-(2,3-dibromopropyl) phosphate, and tetrakis(2-chloroethyl)ethylene diphosphate. Apart from the halogen-substituted phosphates already stated, it is also possible to use inorganic flame retardants with red phosphorus, aluminum oxide hydrate, antimony trioxide, arsenic trioxide, ammonium polyphosphate and calcium sulfate, or cyanuric acid derivatives, melamine for example, or mixtures of at least two flame retardants—for example, ammonium phosphate and melamine—and also, optionally, starch and/or expandable graphite for conferring flame retardancy on the foamed polyesters produced. In general it has proven judicious to use 0 to 50 wt %, preferably 5 to 25 wt %, of the flame retardants or flame retardant mixtures, based on the total weight of the system containing blowing agent.

Before the polymer melt is pressed into the pelletizing chamber, it is mixed with the blowing agent CO₂ or a mixture of CO₂ and N₂. A co-blowing agent may additionally be added to the polymer melt. Co-blowing agents used may be alkanes such as ethane, propane, butane, pentane, alcohols such as ethanol, isopropanol, halogenated hydrocarbons or HCFCs, or a mixture thereof. The sole use of CO₂ or of a mixture of CO₂ and N₂ as blowing agent is particularly advantageous, since these are inert gases which are not flammable, and so no explosion hazard atmosphere is able to form during production. Consequently, expensive safety precautions are unnecessary, and the hazard potential during production is greatly reduced. Another advantageous feature is that there is no need for the products to be stored for a time because of the evaporation of volatile, flammable substances.

Further advantages arise if additionally one or more nucleating agents are added to the polymer melt containing blowing agent. Suitable nucleating agents include, in particular, talc, calcium fluoride, sodium phenylphosphinate, aluminum oxide, carbon black, graphite, pigments, and finely divided polytetrafluoroethylene, in each case individually or else in any desired mixtures. A particularly preferred nucleating agent is talc. The fraction of nucleating agent based on the overall mass of the thermoplastic molding compound or the polymer melt is 0.1 to 2 wt %, more particularly 0.2 to 0.8 wt %.

Generally speaking the biodegradability means that the polyesters (or polyester mixtures) are converted into carbon dioxide, water, and biomass within an appropriate and verifiable time period. Breakdown may take place enzymatically, hydrolytically, oxidatively and/or by exposure to electromagnetic radiation, UV radiation for example, and may usually be brought about predominantly by exposure to microorganisms such as bacteria, yeast, fungi, and algae.

Biodegradability in the sense of compostability is quantifiable, for example, by mixing polyesters with compost and storing the mixture for a certain time. According to DIN EN 13432 (which makes reference to ISO 14855 from 2000-12), for example, CO₂-free air is caused to flow through ripened compost during composting, and the ripened compost is subjected to a defined temperature program. Biodegradability here is defined via the ratio of the net CO₂ release of the sample (after deduction of the CO₂ release by the compost without sample) to the maximum CO₂ release of the sample (calculated from the carbon content of the sample), as a percentage degree of biodegradation. Biodegradable polyesters (and polyester mixtures) generally show clear signs of degradation, such as fungal growth, cracking and holing, after just a few days of composting. Other methods for determining compostability are described for example in ASTM D 5338 and ASTM D 6400-4.

The individual steps (a) to (c) of the process of the invention are described in detail above.

Increasing the water pressure leads in general to lower bulk densities and to a more homogeneous product (narrower bead size distribution).

After leaving the perforated plate, the blowing agent present in the pellets expands, and is brought into contact with a suitable liquid coolant, generally water or a water-containing mixture, thus giving a suspension of expanded foam beads in water or a water-containing mixture.

The expanded foam beads can be separated from the water stream conventionally, as for example by filtration, using a mesh sieve or static sieve, for example, or conventionally via a continuous centrifuge.

The expanded foam beads after step (c) customarily have a bulk density of 5 to 300 kg/m³, preferably of 30 to 150 kg/m³, and more preferably of 60 to 130 kg/m³.

The expanded foam beads are generally at least approximately spherical. The diameter is dependent on the selected bead weight of the original pellets and on the bulk density produced. Customarily, however, the foam beads have a diameter of 1 to 30 mm, preferably 3.5 to 25 mm, and more particularly 4.5 to 20 mm. In the case of nonspherical foam beads, examples being elongated, cylindrical or ellipsoidal beads, the diameter refers to the longest dimension.

The crystalline structure can be characterized by analyzing the expanded foam beads with differential scanning calorimetry (DSC) according to ISO 11357-3 (German version dated Apr. 1, 2013). This is done by heating 3-5 mg of the foam beads at between 20° C. and 200° C. at a heating rate of 20° C./min and determining the resulting heat flow in the 1st run.

The foam beads may be provided with an antistat. In one preferred embodiment this is done by means of coating.

The expanded foam beads produced in accordance with the invention can be used to produce foamed moldings (foams) by methods known to the skilled person.

For example, the expanded foam beads can be adhesively bonded to one another in a discontinuous or continuous method by means of an adhesive bonding agent, using polyurethane adhesives known from the literature, for example.

Preferably, however, the expanded foam beads of polyester are welded to one another under action of heat in a closed mold (step 2). This is done by filling the mold with the foam beads, then closing the mold and introducing steam or hot air, thereby causing further expansion of the foam beads and their fusing to one another to form foam, preferably with a density in the range from 8 to 300 kg/m³. The foams may be semifinished products, such as slabs, profiles or sheets, for example, or finished parts with simple or complex geometries. Accordingly, the term “foam” includes semifinished foam products and shaped foam components.

With the process according to the invention, first of all, expanded foam beads are produced in accordance with steps (a) to (c) as described above. From the expanded foam beads S it is possible, optionally, to produce the foam beads N by afterfoaming.

The second step comprises the foaming of the expanded foam beads S or N in a corresponding mold to give a shaped component.

In one preferred embodiment the second step is implemented by fusing expanded foam beads S or N to one another under the action of heat in a closed mold. This is done by filling the mold, preferably, with the foam beads and, after closing the mold, introducing steam or hot air, thereby causing further expansion of the foam beads and their fusing to one another to form the shaped component, preferably having a density in the range from 8 to 350 kg/m. The ratio of the density of the shaped component to the bulk density of the expanded foam beads is generally >1.1.

In one especially preferred embodiment, the shaped components are obtained by methods known to the skilled person, such as pressure-fill methods or compression methods, the positive mold method, or crack method, or after prior pressurization. Such methods are disclosed in DE-A 25 42 453 and EP-A-0 072 499.

We have now found that shaped components formed from expanded foam beads based on polybutylene sebacate-coterephthalate, with an average particle weight of 10 to 60 mg/bead, have a high rebound elasticity according to DIN EN ISO 1856 (50%, 22 h, 23° C.) of Jan. 1, 2008 (rebound). The rebound is even higher than that of shaped components produced from expanded foam beads based on polybutylene adipate-coterephthalate.

These shaped components additionally exhibit high tensile and compressive strengths, sufficiently low compression set, and acceptable temperature stability, and can therefore be used for corresponding applications in the sport and leisure sector, in the packaging or automotive industries, and also for technical applications. In view of the high rebound, these shaped components are suitable more particularly for coverings for stall floors, such as cow mattresses, or sports floors, for example.

General Process Protocol

A twin-screw extruder having a screw diameter of 18 mm and a length-to-diameter ratio of 40 is charged with 99.5 weight fractions of a polymer and 0.5 weight fraction of talc (Microtalk IT Extra, Mondo Minerals). The polymer was melted in the melting zone of the twin-screw extruder and mixed with the talc. After the melting of the polymer and the incorporation of the talc, CO₂, or a mixture of CO₂ and N₂, was added as blowing agent. The metered quantities of the blowing agent are listed in each case in the examples in tables. On traversal of the remaining distance within the extruder, the blowing agent and the polymer melt were mixed with one another to form a homogeneous mixture.

For all of the examples, the mixture of polymer, talc, and blowing agent was forced through the perforated disk having a hole with a diameter of 1 mm and was chopped off in the downstream, water-traversed pelletizing chamber by 10 rotating blades attached to a ring of blades. The pressure in the pelletizing chamber is also reported in the examples. Beads having an average size of around 2 mm and a weight of around 2 mg were produced. To determine the bulk density, a 500 ml vessel was filled with the expanded beads, and the weight was determined on a balance.

The results are given in the examples below. Each of the experiments coded “V” is a comparative example.

Materials Used:

Comparative System:

i-V1: Pelprene® P-70B, predominantly aromatic polyester (polybutylene terephthalate) from Toyobo Co, Ltd.,

Biodegradable Polyester

i-1 (Polybutylene adipate-co-terephthalate): to prepare the polyester, 87.3 kg of dimethyl terephthalate, 80.3 kg of adipic acid, 117 kg of 1,4-butanediol and 0.2 kg of glycerol were mixed together with 0.028 kg of tetrabutyl orthotitanate (TBOT), the molar ratio between alcohol component and acid components being 1.30. The reaction mixture was heated to a temperature of 180° C. and reacted at this temperature for 6 hours. The temperature was then raised to 240° C. and the excess dihydroxy compound was distilled off under reduced pressure over a period of 3 hours. Thereafter, at 240° C., 0.9 kg of hexamethylene diisocyanate was metered in slowly over 1 hour.

The resulting polyester i-1 had a melting temperature of 119° C. and a molecular weight (Mn) of 23 000 g/mol.

i-2 (Polybutylene sebacate-co-terephthalate): dimethyl terephthalate (70.11 kg), 1,4-butanediol (90.00 kg), glycerol (242.00 g), tetrabutyl orthotitanate (TBOT) (260.00 g) and sebacic acid (82.35 kg) were charged to a 250 L tank and the apparatus was flushed with nitrogen. Methanol was distilled off until the internal temperature was 200° C. The charge was cooled to about 160° C. and condensed under reduced pressure (<5 mbar) until the internal temperature was 250° C. When the desired viscosity was reached, cooling took place to room temperature. The prepolyester had a viscosity VN of 80 ml/g.

Chain extension was carried out in a compounder. The prepolyester was melted at 220° C. and the melt was admixed dropwise with 0.3 wt %, based on the polyester i, of HDI (hexamethene diisocyanate). Reaction progress was monitored via observation of the torque. When the maximum torque was reached, the reaction mixture was cooled, and the chain-extended, biodegradable polyester was removed and characterized. The polyester i-2 had an MVR of 4.7 cm³/10 min.

i-3 (Polybutylene succinate) Bionolle® 1903 MD from Showa Denko K.K.

Blowing agents ii:

ii-1: blowing agent: carbon dioxide (CO₂)

ii-2: blowing agent: nitrogen (N₂)

### COMPARATIVE EXAMPLES

The experiments were conducted in analogy to example 2 from WO 2014/198779.

The polymer used was a polyester based on 1,4-benzenedicarboxylic acid, dimethyl ester, 1,4-butanediol, and α-hydro-ω-hydroxypoly(oxy-1,4-butanediyl) with a melting range from 200 to 220° C., available for example as Pelprene® P-70B from Toyobo Co, Ltd. This polymer was processed according to the method described above, and the bulk density was determined as described above. The bulk densities for each of the blowing agent fractions added are listed in table 1.

In the comparative examples, the operational parameters set were as follows: the temperature in the extruder in the melting zone and during incorporation of the talc into the polymer was 230° C. The temperature from the extruder housing of the injection site up to the end of the extruder, the melt pump and the diverter valve was lowered to 220° C. A pressure at the end of the extruder of 90 bar was set via the melt pump. The temperature of the perforated disk was increased via electrical heating to a target temperature of 250° C.

TABLE 1
comparative system Pelprene ® P-70B

| | CO₂ | N₂ | Water | |
|---|---|---|---|---|
| Comparative | quantities | quantities | pressure | Bulk density |
| example | [wt %*] | [wt %*] | [bar] | [g/l] |
| V1 | 1.75 | 0 | 5 | 281 |
| V2 | 1.75 | 0 | 10 | 419 |
| V3 | 1.75 | 0 | 15 | 590 |
| V4 | 1.75 | 0.3 | 15 | 560 |
| V5 | 1.75 | 0.3 | 10 | 510 |
| V6 | 1.75 | 0.3 | 5 | 430 |
| V7 | 0.5 | 0 | 1 | 340 |
| V8 | 0.75 | 0 | 1 | 267 |
| V9 | 1 | 0 | 1 | 202 |
| V10 | 1.25 | 0 | 1 | 153 |
| V11 | 1.5 | 0 | 1 | 257 |
| V12 | 1.75 | 0 | 1 | 393 |
| V13 | 2 | 0 | 1 | 372 |
| V14 | 2.5 | 0 | 1 | 379 |

*Based on polyester quantity i-V1

### Examples

The polymer used in examples 1 to 6 was a butylene adipate-co-terephthalate, in feedstock i-1, with a melting range from 100 to 120° C. This polymer was processed according to the method described above, and the bulk density was determined as described above. The bulk densities for each of the blowing agent fractions added are listed in table 2. In the examples, the operational parameters set were as follows: the temperature in the extruder in the melting zone and during incorporation of the talc into the polymer was 180° C. The temperature from the extruder housing of the injection site up to the end of the extruder, the melt pump and the diverter valve was lowered to 160° C. A pressure at the end of the extruder of 90 bar was set via the melt pump. The temperature of the perforated disk was increased via electrical heating to a target temperature of 170° C.

TABLE 2
polybutylene adipate-co-terephthalate i-1 - examples 1 to 6

| | CO₂ | N₂ | | |
|---|---|---|---|---|
| | quantities | quantities | Water | Bulk density |
| Examples | [wt %*] | [wt %*] | pressure [bar] | [g/l] |
| 1 | 2 | 0.3 | 5 | 135 |
| 2 | 2 | 0.3 | 7.5 | 120 |
| 3 | 2 | 0.3 | 10 | 105 |
| 4 | 2 | 0.3 | 15 | 108 |
| 5 | 2 | 0 | 1 | 102 |
| 6 | 3 | 0 | 5 | 127 |

*based on polyester i-1

Example 4 was repeated, but polyester i-1 was not isolated in between but was instead introduced as a polymer melt, via a heated pipeline, into stage (a). Expanded pellets (foam beads) having a bulk density of 105 g/l and a surface quality similar to those of example 4 were obtained.

The polymer used in examples 7 to 9 was a butylene sebacate-co-terephthalate i-2, with a melting range from 100 to 120° C. This polymer was processed according to the method described above, and the bulk density was determined as described above. The bulk densities for each of the blowing agent fractions added are listed in table 3. In the examples, the operational parameters set were as follows: the temperature in the extruder in the melting zone and during incorporation of the talc into the polymer was 180° C. The temperature from the extruder housing of the injection site up to the end of the extruder, the melt pump and the diverter valve was lowered to 160° C. A pressure at the end of the extruder of 90 bar was set via the melt pump. The temperature of the perforated disk was increased via electrical heating to a target temperature of 170° C.

TABLE 2
polybutylene sebacate-co-terephthalate i-2 - examples 7 to 9

| | CO₂ | N₂ | Water | |
|---|---|---|---|---|
| | quantities | quantities | pressure | Bulk density |
| Example | [wt %*] | [wt %*] | [bar] | [g/l] |
| 7 | 2 | 0.3 | 7.5 | 99 |
| 8 | 2 | 0.3 | 10 | 96 |
| 9 | 2 | 0.3 | 15 | 90 |

*based on polyester i-2

In a guideline experiment, example 1 was repeated with polybutylene succinate i-3 Instead of polyester i-1 to give expanded foam beads having a bulk density of 192 g/l. By increasing the temperature of the perforated disk and/or of the water, expanded foam beads with even lower bulk densities ought also to be realizable for polyester i-3.

As set out in table 3 below, the expanded foam beads of examples 2, 3, 7, 8 and 9 were fused in an EHV-C automatic molding machine from Erlenbach to form slabs of length×width×height=50×50×20 [mm].

TABLE 3
fusing using automatic EPS molding machine

| | Transverse | | Transverse | | | | | |
|---|---|---|---|---|---|---|---|---|
| | steam | | steam | | | | | |
| | moving side | | fixed side | | Autoclave | | Autoclave | |
| | | Pres- | | Pres- | moving side | | fixed side | |
| | Time | sure | Time | sure | Time | Pressure | Time | Pressure |
| Example | [s] | [bar] | [s] | [bar] | [s] | [bar] | [s] | [bar] |
| 2 | 6 | 0.2 | 6 | 0.3 | 2 | 0.7 | 2 | 0.7 |
| 3 | 6 | 0.2 | 6 | 0.3 | 2 | 0.2 | 2 | 0.3 |
| 7 | 2 | 0.1 | 2 | 0.1 | 2 | 0.1 | 2 | 0.1 |
| 8 | 2 | 0.1 | 2 | 0.1 | 2 | 0.1 | 2 | 0.1 |
| 9 | 4 | 0.1 | 4 | 0.1 | 2 | 0.1 | 2 | 0.1 |

The following pressure test of table 4 was carried out in accordance with the German version of standard EN 826: 2013 (Determination of behavior under pressure exposure for thermal insulating materials for building). The rebound elasticity (rebound) was determined according to standard DIN 53512 of April 2000.

TABLE 4
mechanical data under pressure

| | | Pressure test | | | | | |
|---|---|---|---|---|---|---|---|
| | | | F10% | F25% | F50% | Rebound | |
| | | Density | Pressure | Pressure | Pressure | Density | Rebound |
| Example | Sample | [kg/m³] | [kPa] | [kPa] | [kPa] | [kg/m³] | [%] |
| 2 | 1 | 261.9 | 23.9 | 160.9 | 452.3 | 267.8 | 64.2 |
| | 2 | 259.8 | 35.2 | 190.5 | 514.3 | 262.2 | 63.6 |
| | 3 | | | | | 272.5 | 63.0 |
| 3 | 1 | 236.7 | 28.7 | 165.4 | 407.1 | 241.4 | 63.6 |
| | 2 | 279.7 | 66.5 | 260.4 | 700.6 | 254.2 | 63.0 |
| | 3 | 242.5 | 33.0 | 183.1 | 495.0 | 299.9 | 62.0 |
| 7 | 1 | 276.8 | 24.8 | 129.8 | 370.2 | 276.2 | 67.8 |
| | 2 | 236.0 | 22.2 | 95.3 | 285.8 | 241.7 | 66.2 |
| | 3 | 261.2 | 41.2 | 141.9 | 389.7 | 281.9 | 67.6 |
| 8 | 1 | 205.9 | 37.4 | 111.5 | 281.8 | 172.2 | 71.8 |
| | 2 | 190.3 | 18.6 | 78.8 | 204.4 | 195.5 | 67.8 |
| | 3 | 145.5 | 12.8 | 52.0 | 143.6 | 210.0 | 70.6 |
| 9 | 1 | 196.6 | 18.6 | 66.7 | 208.6 | 186.6 | 74.8 |
| | 2 | 184.4 | 21.1 | 68.8 | 196.0 | 185.9 | 76.0 |
| | 3 | 177.1 | 14.8 | 58.1 | 180.3 | 202.9 | 73.6 |

1.-14. (canceled)

15. A process for production of expanded foam beads of one or more polyesters based on aliphatic or aliphatic and aromatic dicarboxylic acids and aliphatic diols, comprising the steps of:
(a) melting the polyester and admixing the polyester or mixture thereof with 1 to 3.5 wt %, based on the polyester, of carbon dioxide and/or nitrogen blowing agent and also 0.1 to 2 wt % of a nucleating agent, and pressing the nucleated polyester melt, containing blowing agent, through a perforated disk controlled to a temperature between 150° C. and 185° C. and into a pelletizing chamber,
(b) using a cutting device to comminute the polymer melt pressed through the perforated disk into individual expanding pellets,
(c) discharging the pellets from the pelletizing chamber into a stream of water which is at a temperature of 5 to 90° C. and a pressure of 0.1 bar to 20 bar above ambient pressure, wherein the polyester is biodegradable according to DIN EN 13432 (2000-12).

16. The process according to claim 15, wherein the polyester has a construction as follows:
A1) 40 to 100 mol %, based on components A1) and A2), of an aliphatic dicarboxylic acid or mixtures thereof,
A2) 0 to 60 mol %, based on components A1) and A2), of an aromatic dicarboxylic acid or mixtures thereof,
B) 98.5 to 100 mol %, based on components A1) to A2), of a diol component comprising a C₂ to C₁₂ alkanediol or mixtures thereof, and
C) 0.05 to 1.5 wt %, based on components A1) to A2) and B, of one or more compounds selected from the group consisting of:
C1) a compound having at least three groups capable of forming esters,
C2) a compound having at least two isocyanate groups, and
C3) a compound having at least two epoxide groups.

17. The process according to claim 16, wherein the polyester has a composition as follows:
component A1: succinic acid, adipic acid, azaleic acid or sebacic acid or mixtures thereof,
component A2: terephthalic acid, and
component B: 1,4-butanediol or 1,3-propanediol.

18. The process according to claim 16, wherein the polyester is a polybutylene adipate-co-terephthalate.

19. The process according to claim 16, wherein the polyester is a polybutylene sebacate-co-terephthalate or a mixture of a polybutylene adipate-co-terephthalate and polybutylene-sebacate-co-terephthalate.

20. The process according to claim 15, wherein the polyester of
Ai) 90 to 100 mol %, based on components Ai to Aii, of succinic acid;
Aii) 0 to 10 mol %, based on components Ai to Aii, of one or more C₆-C₁₈ dicarboxylic acids;
B) 99 to 100 mol %, based on components Ai to Aii, of 1,3-propanediol or 1,4-butanediol or mixtures thereof;
C) 0 to 1 wt %, based on components Ai to Aii, B and C, of a diisocyanate and/or a compound having at least three groups capable of forming esters.

21. The process according to claim 15, wherein a blowing agent mixture of carbon dioxide and nitrogen in a ratio of 10:1 to 2:1 is used in step a).

22. The process according to claim 21, wherein the stream of water in step c) has a pressure of 4 bar to 20 bar above ambient pressure.

23. The process according to claim 15, wherein the blowing agent used in step a) exclusively is carbon dioxide wherein the stream of water in step c) has a pressure of 0.5 bar to 5 bar above ambient pressure.

24. A process for production of expanded foam beads of a polyester based on aliphatic or aliphatic and aromatic dicarboxylic acids and aliphatic diols, comprising the steps of:
(x) adding aliphatic or aliphatic and aromatic dicarboxylic acids and aliphatic diols, and optionally further reactants, that are used for preparing a polyester melt, into a first stage of a polymer processing machine,
(a) introducing the polyester melt into a second polymer processing machine and admixing the polyester melt with 1 to 3.5 wt %, based on the polyester, of blowing agent carbon dioxide and/or nitrogen and also 0.1 to 2 wt % of a nucleating agent, and pressing the nucleated polyester melt, containing blowing agent, through a perforated disk controlled to a temperature between 150° C. and 185° C. and into a pelletizing chamber,
(b) using a cutting device to comminute the polymer melt pressed through the perforated disk into individual expanding pellets,
(c) discharging the pellets from the pelletizing chamber into a stream of water which is at a temperature of 5 to 90° C. and a pressure of 0.1 bar to 20 bar above ambient pressure,
wherein the polyester is biodegradable according to DIN EN 13432 (2000-12)

25. The process according to claim 24, wherein in stage (x) the polyester melt is produced continuously, optionally by addition of a chain extender, and has a melt volume rate (MVR) according to ISO 1133 of 0.5 to 10 cm³/10 min (190° C., 2.16 kg weight).

26. The process according to claim 24, wherein the chain extender is added in stage (x).

27. The process according to claim 24, wherein the chain extender is added in stage (a) before or at the same time as the blowing agent and the nucleating agent are added.

28. The process according to claim 15, wherein stage (a) is carried out in an extruder, List reactor or static mixer.
